(19) United States
(12) Patent Application Publication
(10) Pub. No.: US 2016/0064947 A1
(43) Pub. Date: Mar. 3, 2016

(54) Adjusting Operations in an Electronic Device Based on Environmental Data

(71) Applicant: Apple Inc., Cupertino, CA (US)

(72) Inventors: Amaury J. Heresztyn, Cupertino, CA (US); Nagarajan Kalyanasundaram, Cupertino, CA (US); John M. Ananny, Cupertino, CA (US); Keith Cox, Cupertino, CA (US); Frank F. Liang, Cupertino, CA (US); Eugene Y. Kim, Cupertino, CA (US); Mushtaq A. Sarwar, Cupertino, CA (US); Jim C. Hwang, Cupertino, CA (US); Jean-Pierre S. Guillou, Cupertino, CA (US); Paul S. Drzaic, Cupertino, CA (US); Peter M. Arnold, Cupertino, CA (US); Storrs T. Hoen, Cupertino, CA (US); Douglas A. Scott, Cupertino, CA (US); Anthony J. Guetta, Cupertino, CA (US)

(21) Appl. No.: 14/831,712

(22) Filed: Aug. 20, 2015

Related U.S. Application Data
(60) Provisional application No. 62/044,798, filed on Sep. 2, 2014.

(51) Int. Cl. H02J 5/00; H05B 37/02; H02J 7/02; H01F 38/14; H02J 17/00

(52) U.S. Cl. CPC H02J 5/005; H01F 38/14; H02J 17/00; H02J 7/025; H05B 37/02

(57) ABSTRACT

One or more operations in an electronic device can be adjusted based on environment data, such as temperature data and/or humidity data. The electronic device may be, for example, a receiver device or a transmitter device in an inductive energy transfer system. Example operations that may be adjusted based on environmental data include, but are not limited to, the brightness of a display or a haptic output produced by a haptic mechanism.

### CROSS-REFERENCE TO RELATED APPLICATION

This application claims the benefit under 35 U.S.C. §119(e) of U.S. Provisional Patent Application No. 62/044,798, filed on Sep. 2, 2014, and entitled “Adjusting Operations in an Electronic Device Based on Environmental Data,” which is incorporated by reference as if fully disclosed herein.

### FIELD

The invention relates generally to electronic devices, and more particular to techniques for managing or adjusting operations in an electronic device based on environmental data.

### BACKGROUND

Consumer electronic devices such as smart telephones, digital media players, and tablet computing devices are becoming ubiquitous in everyday life. These electronic devices include an assortment of components and devices that allow the electronic device to perform a variety of functions. For example, an electronic device can include a display, a haptic feedback mechanism, and various sensors such as light sensors, biometric sensors, and position or motion sensors. In some situations, the operations or performance of an electronic device can be impacted by environmental conditions. Factors such as temperature and humidity can degrade the operations of the electronic device. For example, cold temperatures can affect a liquid crystal display (LCD) screen, reduce the effectiveness of a battery, or damage disk drives. With an LCD screen, the screen may dim or be less bright as a result of cold temperatures.

### BRIEF DESCRIPTION OF THE DRAWINGS

Embodiments of the invention are better understood with reference to the following drawings. The elements of the drawings are not necessarily to scale relative to each other. Identical reference numerals have been used, where possible, to designate identical features that are common to the figures.

FIG. 1 illustrates one example of an inductive energy transfer system in an unmated configuration;

FIG. 2 depicts the inductive energy transfer system 100 in a mated configuration;

FIG. 3 depicts a simplified block diagram of one example of the inductive energy transfer system 100 shown in FIG. 1;

FIG. 4 illustrates a simplified block diagram of an example device suitable for use as a receiver device or a transmitter device;

FIG. 5 is a simplified cross-section view of the inductive energy transfer system taken along line 5-5 in FIG. 2;

FIG. 6 is a flowchart of a method of managing an operation of a device in a receiver device based on temperature;

FIG. 7 is a flowchart of one example method of managing a display in a receiver device based on temperature;

FIG. 8 is a flowchart of another example method of managing a display in a receiver device based on temperature;

FIG. 9 is a flowchart of one example method of managing a haptic output in a receiver device based on temperature;

FIG. 10 is a flowchart of a method of selecting an alert type in a receiver device based on temperature;

FIG. 11 is a flowchart of a method of operating the inductive energy transfer system shown in FIG. 1 based on temperature; and

FIG. 12 is a flowchart of a method of operating the receiver device based on humidity.

### SUMMARY

The operations of one or more devices in an electronic device can be adjusted based on environment data, such as temperature data and/or humidity data. As one example, the brightness of a display can be increased or decreased based on temperature data. As another example, the haptic output of a haptic mechanism can be varied based on temperature data.

In one aspect, a method of managing an operation of a device in an electronic device can include receiving environmental data and determining whether to adjust an operation of the device based on the environmental data. If the operation of the device is to be adjusted based on the environmental data, the operation of the device is adjusted. As one example, a brightness of a display can be adjusted (e.g., increased or decreased) based on the environmental data. As another example, a haptic output of a haptic mechanism may be adjusted (e.g., increased or decreased) based on the environmental data. In one embodiment, the environmental sensor includes a temperature sensor and the environmental data includes temperature data. In some embodiments, the electronic device may be a receiver device or a transmitter device in an inductive energy transfer system.

In another aspect, an electronic device can include an environmental sensor, a network communication interface, and a processing device configured to receive environmental data from at least one of the environmental sensor or the network communication interface and adjust an operation in the electronic device based on the environmental data. As one example, a brightness of a display can be adjusted (e.g., increased or decreased) based on the environmental data. As another example, a haptic output of a haptic mechanism may be adjusted (e.g., increased or decreased) based on the environmental data. In one embodiment, the environmental sensor includes a temperature sensor and the environmental data includes temperature data. In some embodiments, the electronic device may be a receiver device or a transmitter device in an inductive energy transfer system.

In another aspect, an inductive energy transfer system includes a transmitter device and a receiver device. The transmitter device is configured to transfer energy inductively to the receive device. In one embodiment, the transmitter device can include first communication circuitry. The receiver device can include an environmental sensor, a network communication interface, and second communication circuitry. A processing device in the receiver device may be operably connected to the environmental sensor, the network communication interface, and the second communication circuitry. The processing device can be configured to receive environmental data from at least one of the environmental sensor, the network communication interface, or a communication channel established between the first and second communication circuitry and adjust an operation in the receiver device based on the environmental data. As one example, a brightness of a display can be adjusted (e.g., increased or decreased) based on the environmental data. As another example, a haptic output of a haptic mechanism may be adjusted (e.g., increased or decreased) based on the environmental data. In one embodiment, the environmental sensor includes a temperature sensor and the environmental data includes temperature data.

In another embodiment, the receiver device can include first communication circuitry. The transmitter device can include an environmental sensor, a network communication interface, and second communication circuitry. A processing device in the transmitter device may be operably connected to the environmental sensor, the network communication interface, and the second communication circuitry. The processing device can be configured to receive environmental data from at least one of the environmental sensor, the network communication interface, or a communication channel established between the first and second communication circuitry and adjust an operation in the transmitter device based on the environmental data.

In yet another aspect, an alert type in an electronic device can be selected based on environment data, such as, for example, temperature data. The electronic device receives environmental data and determines if an alert type is to be selected based on the environmental data. In one example embodiment, a user can enable alert type selection based on temperature through a user preference menu or a control panel. Alternatively, a processing device can be configured to select the alert type based on temperature. If the alert type will not be selected based on the environmental data, a predetermined or default alert may be output. If the alert type is to be selected based on the environmental data, the alert can be selected and output to the user.

### DETAILED DESCRIPTION

Various embodiments that are described herein provide techniques for managing or adjusting device operations based on environmental data, such as temperature data. A receiver device in an inductive energy transfer system is used herein to describe various embodiments. However, the techniques described herein can be used with any type of electronic device. Example electronic devices include, but are not limited to, a transmitter device in an inductive energy transfer system, a smart telephone, a digital media player, a wearable electronic or communication device, a tablet computing device, and a laptop computer.

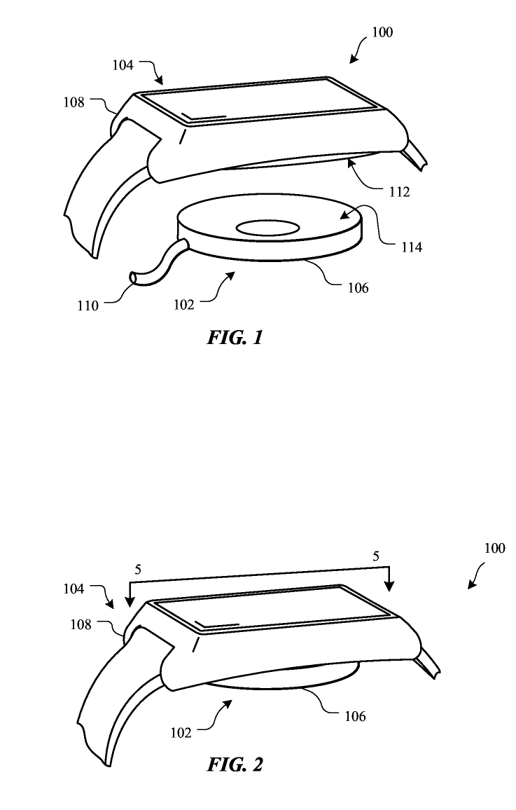

Referring now to FIG. 1, there is shown a perspective view of one example of an inductive energy transfer system in an unmated configuration. The illustrated embodiment depicts a transmitter device 102 that is configured to wirelessly transfer energy to a receiver device 104. The receiver device 104 can be any electronic device that includes one or more inductors. Example electronic devices include, but are not limited to, a portable electronic device or a wearable communication device.

The wearable communication device, such as the one depicted in FIG. 1, may be configured to provide, for example, wireless electronic communication from other devices and/or health-related information or data such as but not limited heart rate data, blood pressure data, temperature data, oxygen level data, diet/nutrition information, medical reminders, health-related tips or information, or other health-related data. The wearable communication device may include a coupling mechanism to connect a strap or band to a user. For example, a smart watch may include a band or strap to secure to a user's wrist. In another example, a wearable health assistant may include a strap to connect around a user's chest, or alternately, a wearable health assistant may be adapted for use with a lanyard or necklace. In still further examples, a wearable device may secure to or within another part of a user's body. In these and other embodiments, the strap, band, lanyard, or other securing mechanism may include one or more electronic components or sensors in wireless or wired communication with the communication device. For example, the band secured to a smart watch may include one or more sensors, an auxiliary battery, a camera, or any other suitable electronic component.

In many examples, a wearable communication device, such as the one depicted in FIG. 1, may include a processing device coupled with, or in communication with a memory, one or more communication interfaces, output devices such as displays and speakers, one or more sensors, such as biometric and imaging sensors, and input devices such as one or more buttons, one or more dials, a microphone, and/or a touch sensing device. The communication interface(s) can provide electronic communications between the communications device and any external communication network, device or platform, such as but not limited to wireless interfaces, Bluetooth interfaces, Near Field Communication interfaces, infrared interfaces, USB interfaces, Wi-Fi interfaces, TCP/IP interfaces, network communications interfaces, or any conventional communication interfaces. The wearable communication device may provide information regarding time, health, statuses or externally connected or communicating devices and/or software executing on such devices, messages, video, operating commands, and so forth (and may receive any of the foregoing from an external device), in addition to communications.

Although the wearable communication device illustrated in FIGS. 1 and 2 depicts a wristwatch or smart watch, any electronic device may be suitable to receive energy inductively from a transmitter device. For example, a suitable electronic device may be any portable or semi-portable electronic device that may receive energy inductively (“receiver device”), and a suitable dock device may be any portable or semi-portable docking station or charging device that may transmit energy inductively (“transmitter device”). Example electronic devices include, but are not limited to, a smart telephone, a gaming device, a digital music player, a tablet computing device, and other types of portable and consumer electronic devices that are configured to transmit and/or receive energy inductively.

The transmitter device 102 and the receiver device 104 may each respectively include a housing 106, 108 to enclose electronic, mechanical and structural components therein. In many examples, and as depicted, the receiver device 104 may have a larger lateral cross section than that of the transmitter device 102, although such a configuration is not required. In other examples, the transmitter device 102 may have a larger lateral cross section than that of the receiver device 104. In still further examples, the cross sections may be substantially the same. And in other embodiments, the transmitter device can be adapted to be inserted into a charging port in the receiver device.

In the illustrated embodiment, the transmitter device 102 may be connected to a power source by cord or connector 110. For example, the transmitter device 102 can receive power from a wall outlet, or from another electronic device through a connector, such as a USB connector. Additionally or alternatively, the transmitter device 102 may be battery operated. Similarly, although the illustrated embodiment is shown with the connector 110 coupled to the housing of the transmitter device 102, the connector 110 may be connected by any suitable means. For example, the connector 110 may be removable and may include a connector that is sized to fit within an aperture or receptacle opened within the housing 106 of the transmitter device 102.

The receiver device 104 may include a first interface surface 112 that may interface with, align or otherwise contact a second interface surface 114 of the transmitter device 102. In this manner, the receiver device 104 and the transmitter device 102 may be positionable with respect to each other. In certain embodiments, the second interface surface 114 of the transmitter device 102 may be configured in a particular shape that mates with a complementary shape of the receiver device 104 (see FIG. 2). The illustrative second interface surface 114 may include a concave shape that follows a selected curve. The first interface surface 112 of the receiver device 104 may include a convex shape following the same or substantially similar curve as the second interface surface 114.

In other embodiments, the first and second interface surfaces 112, 114 can have any given shape and dimension. For example, the first and second interface surfaces 112, 114 may be substantially flat. Additionally or alternatively, the transmitter and receiver devices 102, 104 can be positioned with respect to each other using one or more alignment mechanisms. As one example, one or more magnetic devices may be included in the transmitter and/or receiver devices and used to align the transmitter and receiver devices. In another example, one or more actuators in the transmitter and/or receiver devices can be used to align the transmitter and receiver devices. And in yet another example, alignment features, such as protrusions and corresponding indentations in the housings of the transmitter and receiver devices, may be used to align the transmitter and receiver devices. The design or configuration of the interface surfaces, one or more alignment mechanisms, and one or more alignment features can be used individually or in various combinations thereof.

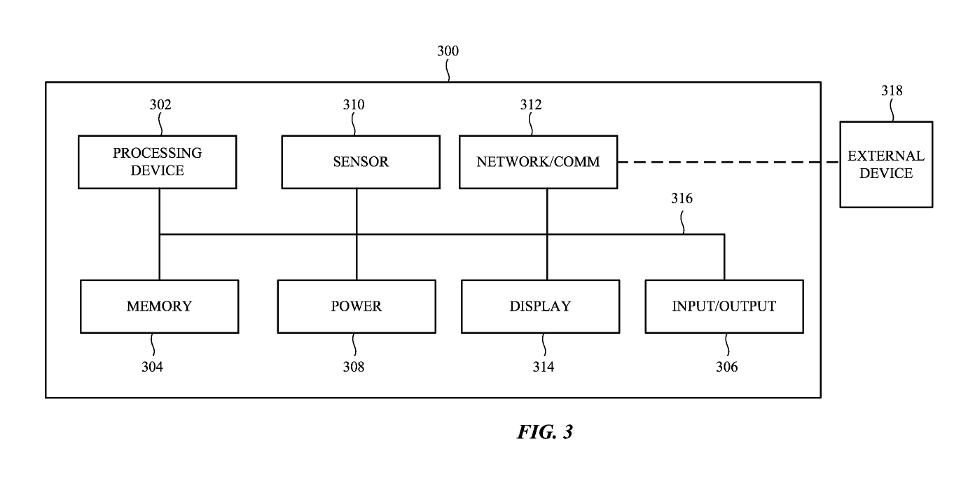

The transmitter device and the receiver device can each include a number of internal components. FIG. 3 is a simplified block diagram of an example electronic device that is suitable for use as a receiver device or a transmitter device. The electronic device 300 can include one or more processing devices 302, memory 304, one or more input/output (I/O) devices 306, a power source 308, one or more sensors 310, a network communication interface 312, and a display 314, each of which will be discussed in turn below.

The one or more processing devices 302 can control some or all of the operations of the electronic device 300. The processing device(s) 302 can communicate, either directly or indirectly, with substantially all of the components of the device. For example, one or more system buses 316 or other communication mechanisms can provide communication between the processing device(s) 302, the memory 304, I/O device 306, a power source 308, one or more sensors 310, a network communication interface 312, and a display 314. At least one processing device can be configured to determine if the operation of one or more devices or functions in the electronic device 300 is to be adjusted based on environmental data, such as temperature. Additionally or alternatively, the processing device may be configured to adjust the operation (e.g., adjust a stimulus that is received by a device performing the operation) based on the environmental data.

The processing device(s) 302 can be implemented as any electronic device capable of processing, receiving, or transmitting data or instructions. For example, the one or more processing devices 302 can be a microprocessor, a central processing unit (CPU), an application-specific integrated circuit (ASIC), a digital signal processor (DSP), or combinations of multiple such devices. As described herein, the term “processing device” is meant to encompass a single processor or processing unit, multiple processors, multiple processing units, or other suitably configured computing element or elements.

The memory 304 can store electronic data that can be used by the electronic device 300. For example, the memory 304 can store electrical data or content such as audio files, document files, timing and control signals, operational settings and data, and image data. The memory 304 can be configured as any type of memory. By way of example only, memory 304 can be implemented as random access memory, read-only memory, Flash memory, removable memory, or other types of storage elements, in any combination.

The one or more I/O devices 306 can transmit and/or receive data to and from a user or another electronic device. Example I/O device(s) 306 include, but are not limited to, a touch sensing input device such as a touchscreen or track pad, one or more buttons, a microphone, and/or a speaker.

The power source 308 can be implemented with any device capable of providing energy to the electronic device 300. For example, the power source 308 can be one or more batteries or rechargeable batteries, or a connection cable that connects the electronic device to another power source such as a wall outlet.

The electronic device 300 may also include one or more sensors 310 positioned substantially anywhere on or in the electronic device 300. The sensor or sensors 310 may be configured to sense substantially any type of characteristic, such as but not limited to, images, pressure, light, heat, touch, force, temperature, humidity, movement, relative motion, biometric data, and so on. For example, the sensor(s) 310 may be an image sensor, a temperature sensor, a light or optical sensor, an accelerometer, an environmental sensor, a gyroscope, a magnet, a health monitoring sensor, and so on.

The network communication interface 312 can facilitate transmission of data to or from other electronic devices. For example, a network communication interface can transmit electronic signals via a wireless and/or wired network connection. For example, in one embodiment a communication signal is transmitted to a transmitter device and/or to a receiver device to permit the transmitter and receiver devices to communication with one another. Examples of wireless and wired network connections include, but are not limited to, cellular, Wi-Fi, Bluetooth, infrared (IR), Ethernet, and Near Field Communication (NFC).

In some embodiments, an external device 318 can transmit signals to the electronic device 300 that cause one or more operations of the electronic device (e.g., the display operations) to be modified based on one or more environmental conditions. Similarly, the electronic device 300 can transmit signals to the external device 318 to manage the operations of one or more devices in the external device 318. In some embodiments, the signals are transmitted between the network communication interface 312 in the electronic device and a network communication interface (not shown) in the external device 318. A processing device in the external device 318 can be configured to determine if the operation of one or more devices in the external device is to be adjusted based on environmental data, such as temperature.

The display 314 can provide a visual output to the user. The display 314 can be implemented with any suitable technology, including, but not limited to, a multi-touch sensing touchscreen that uses liquid crystal display (LCD) technology, light emitting diode (LED) technology, organic light-emitting display (OLED) technology, organic electroluminescence (OEL) technology, or another type of display technology. In some embodiments, the display 314 can function as an input device that allows the user to interact with the electronic device 300. For example, the display can be a multi-touch touchscreen display.

It should be noted that FIG. 3 is exemplary only. In other examples, the electronic device may include fewer or more components than those shown in FIG. 3. Additionally or alternatively, the electronic device can be included in a system and one or more components shown in FIG. 3 is separate from the electronic device but in communication with the electronic device. For example, an electronic device may be operatively connected to, or in communication with a separate display. As another example, one or more applications or data can be stored in a memory separate from the electronic device. As another example, a processing device in communication with the electronic device can control various functions in the electronic device and/or process data received from the electronic device. In some embodiments, the separate memory and/or processing device can be in a cloud-based system or in an associated device.

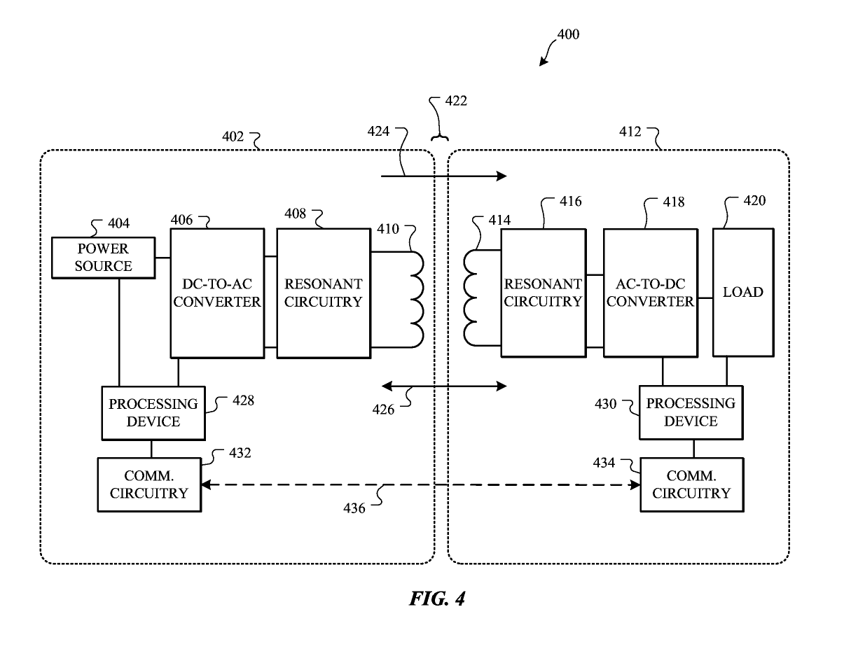

Referring now to FIG. 4, there is shown a simplified schematic diagram of a first example of an inductive energy transfer system that is suitable for use as the inductive energy transfer system shown in FIGS. 1 and 2. The transmitter device 402 includes a power source 404 operably connected to a DC-to-AC converter 406. As described earlier, an example power source includes, but is not limited to, a wall outlet or another electronic device that is connected to the transmitter device 402 by a connector or cord (see 110 in FIG. 1). Additionally or alternatively, the power source 404 may be one or more batteries.

Any suitable type of a DC-to-AC converter may be used in the transmitter device 402. For example, the DC-to-AC converter can be constructed as an H bridge in one embodiment. The DC-to-AC converter 406 is operatively connected to transmitter resonant circuitry 408. The transmitter resonant circuitry 408 is operatively connected to a transmitter coil 410.

The receiver device 412 can include a receiver coil 414 operably connected to receiver resonant circuitry 416. The receiver resonant circuitry 416 is operatively connected to an AC-to-DC converter 418. Any suitable type of AC-to-DC converter may be used. For example, the AC-to-DC converter can be constructed as a diode bridge in one embodiment.

A load 420 is operably connected to the output of the AC-to-DC converter 418. The load 420 is a rechargeable battery in one embodiment. Other embodiments can use a different type of load.

The transmitter coil 410 and the receiver coil 414 together form a transformer 422. The transformer 422 transfers power or energy through inductive coupling between the transmitter coil 410 and the receiver coil 414 (energy transfer represented by arrow 424). Essentially, energy is transferred from the transmitter coil 410 to the receiver coil 414 through the creation of a varying magnetic flux by an AC signal flowing through the transmitter coil 410. The varying magnetic flux induces a current in the receiver coil 414. The AC signal induced in the receiver coil 414 is received by the AC-to-DC converter 418 that converts the AC signal into a DC signal. In embodiments where the load 420 is a rechargeable battery, the DC signal is used to charge the battery. Additionally or alternatively, the transferred energy can be used to transmit communication signals to or from the receiver device (communication signals represented by arrow 426).

A processing device 428 in the transmitter device 402 can be operatively connected to the power source 404 and/or the DC-to-AC converter 406. Although not shown in FIG. 4, the processing device 428 may be operatively connected to other components (e.g., display, sensor, memory) in the transmitter device. The processing device 428 may control or monitor the power produced by the power source 404. Additionally or alternatively, the processing device 428 can control or monitor the operation of the DC-to-AC converter 406. As one example, when the DC-to-AC converter is configured as an H bridge, the processing device 428 may control the opening and closing of the switches in the H bridge.

A processing device 430 in the receiver device 412 can be operatively connected to the AC-to-DC converter 418 and/or the load 420. Although not shown in FIG. 4, the processing device 430 may be operatively connected to other components (e.g., sensor, memory, display) in the receiver device. The processing device 430 may control or monitor the operation of the AC-to-DC converter 418 or the load 420. As one example, the processing device 430 may monitor the charge level on the load 420 when the load is configured as a rechargeable battery.

Communication circuitry 432, 434 may be operatively connected to the processing devices 428, 430 in the transmitter and receiver devices 402, 412, respectively. The communication circuitry 432, 434 can be used to establish a communication channel 436 between the transmitter and receiver devices. As described earlier, inductive energy transfer can be used for communication between the transmitter and receiver devices. The communication channel 436 is an additional communication mechanism that is separate from inductive energy transfer. The communication channel 436 is used to convey information from the transmitter device 402 to the receiver device 412, and vice versa. The communication channel 436 may be implemented as a physical or wired link, or as a wireless link. In one embodiment, the communication channel 436 is configured as any suitable digital communication channel that is used to transmit a communication signal (e.g., a digital bit stream or packets) between the transmitter and receiver devices.

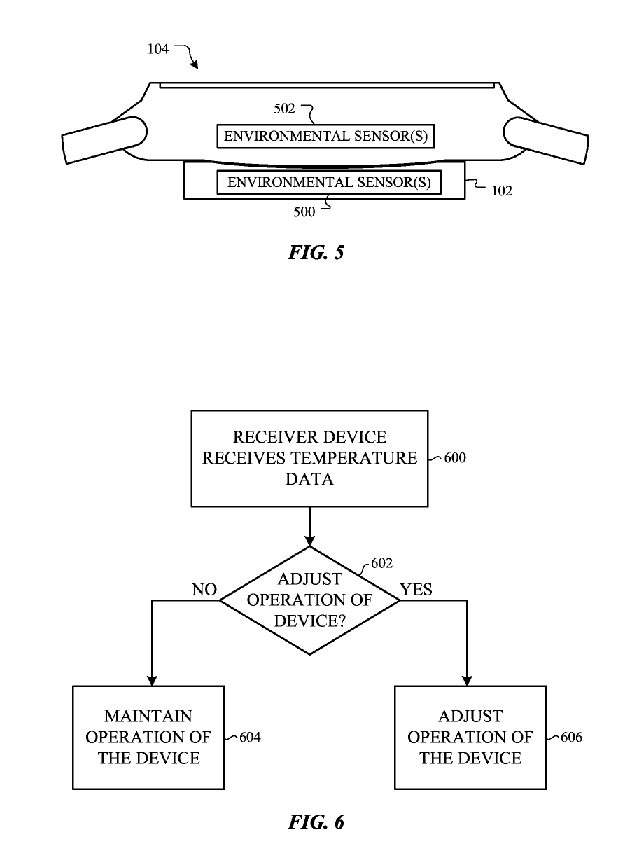

FIG. 5 is a simplified cross-section view of the inductive energy transfer system taken along line 5-5 in FIG. 2. As discussed earlier, both the transmitter device 102 and the receiver device 104 can include electronic, mechanical, and/or structural components. For example, both the receiver and the transmitter devices can include one or more processing devices, memory, a network communication interface, and one or more input/output devices. The illustrated embodiment of FIG. 5 omits the electronic, mechanical, and/or structural components for simplicity.

In some embodiments, one electronic device (e.g., the receiver device) can receive environmental data that assists the electronic device in managing the operations of one or more devices in the electronic device. In some embodiments, the transmitter device 102 and the receiver device 104 can each include one or more environmental sensors 500, 502, respectively. In the illustrated embodiment, the environmental sensors are temperature sensors. The temperature sensors can be included in the sensors 310 shown in FIG. 3. One example of a temperature sensor is a thermistor. The temperature sensor(s) in the transmitter device can sense the temperature of the transmitter device and the temperature sensor(s) in the receiver device can sense the temperature of the receiver device. The receiver device can adjust the operations of one or more devices in the receiver device based on the temperatures sensed by the temperature sensor in the receiver device. Similarly, the transmitter device can modify the operation of one or more devices in the transmitter device based on the temperatures sensed by the temperature sensor in the transmitter device.

In some embodiments, the temperature may be measured by a first device (e.g., the transmitter device) and transmitted to a second device (e.g., the receiver device). The second device can adjust the operation of one or more devices based on the temperature sensed by, and received from, the first device. For example, the first device can transmit temperature data to the second device using a communication channel (e.g., communication channel 436 in FIG. 4).

Additionally or alternatively, the transmitter device and/or the receiver device can include a network communication interface (e.g., see network communication interface 312 in FIG. 3). The transmitter device and/or the receiver device may receive environmental data (e.g., temperature data) from an external device using the network communication interface.

Embodiments are described as adjusting the operation of an electronic device based on temperature or humidity data. Those skilled in the art will recognize that the operations can be modified based on environmental data other than temperature and humidity. For example, one or more operations can be adjusted based on atmospheric pressure or wind speed. Thus, embodiments can modify the behavior of a device or operation in an electronic device based on environmental data (e.g., temperature) so that a user has a substantially consistent user experience with the electronic device.

FIGS. 6-10 are described in conjunction with the receiver device in an inductive energy transfer system. But those skilled in the art will recognize the methods can be used in a transmitter device or in another type of electronic device. FIG. 6 is a flowchart of a method of managing an operation of a device in a receiver device based on temperature. Initially, as shown in block 600, the receiver device receives temperature data. As described earlier, the receiver device can receive temperature data in any suitable manner. For example, in one embodiment the receiver device can receive the temperature data from a temperature sensor in the receiver device. In another embodiment, the receiver device can receive the temperature data from a temperature sensor in the transmitter device. In other embodiments, the receiver device can receive temperature data from a network, such as the Internet, Bluetooth, or a cellular network (e.g., through the network communication interface 312 in FIG. 3).

A determination may then be made at block 602 as to whether or not an operation of a device is to be adjusted based on the temperature data. If not, the process passes to block 604 where the operation of the device is maintained at the current operating state. If the operation is to be adjusted, the method continues at block 606 where the operation, or a stimulus that is received by a device performing the operation, is adjusted. In one embodiment, a processing device (e.g., processing device 302) can be adapted to perform the operation in block 602 and/or block 604.

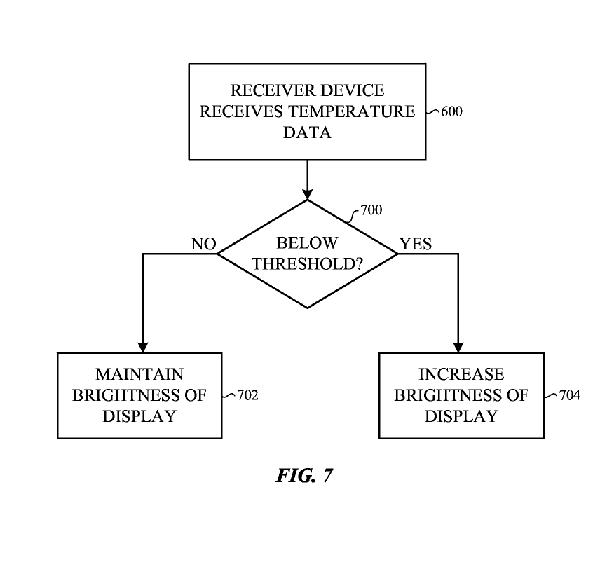

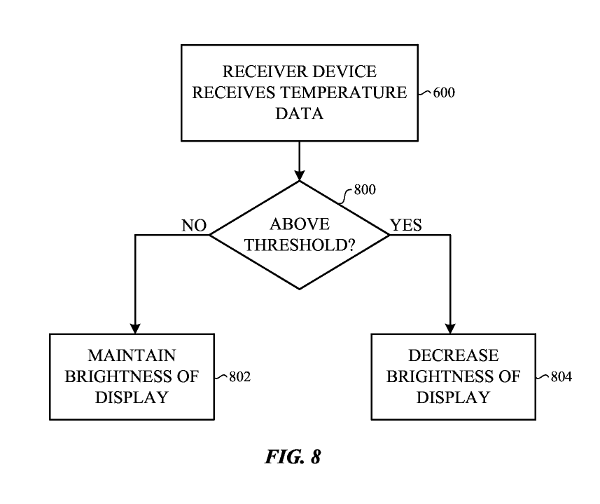

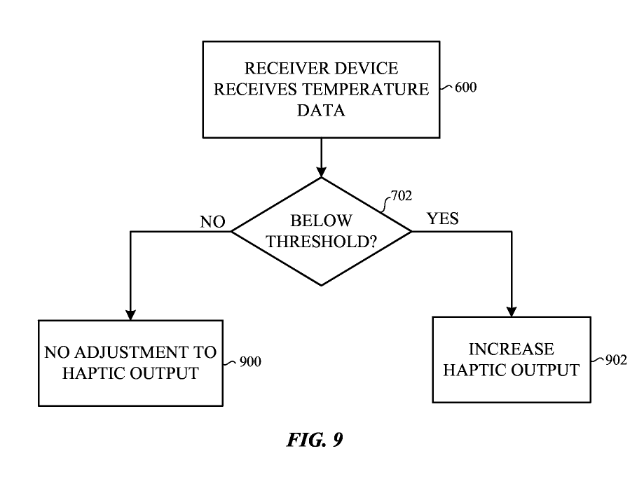

As one example, the operation of a display can be managed based on temperature. Adjusting the operation of a display as temperature varies may reduce or eliminate the adverse impact temperature variations can have on a display over the lifetime of the display. FIGS. 7 and 8 depict flowcharts of methods of managing a display in a receiver device based on temperature. As described earlier, the operation of a display can be adversely impacted by colder temperatures. The method of FIG. 7 compensates for the colder temperature by increasing the brightness of the display so the display maintains a relatively consistent brightness regardless of the temperature and the user has a substantially uniform experience with the display.

Initially, the receiver device receives temperature data at block 600. A determination may then be made as to whether or not the temperature data is below a given threshold (block 700). The threshold can be a single threshold or a set of multiple thresholds. With two or more thresholds, multiple adjustments can be made to an operation of the display as the temperature varies over time (e.g., as the temperature becomes colder over time). The threshold or thresholds can be implemented as any type of a threshold value. As one example, the threshold may be actual temperature values that are compared with the received temperature data. As another example, the threshold may be variations in magnitude, such as a percentage variation or a difference amount. Additionally, the threshold(s) can be stored in any format in memory. In one embodiment, the threshold(s) can be stored in a lookup table along with the adjustments to be made to one or more operations or devices.

Returning to FIG. 7, if the temperature data is not below the threshold, the process continues at block 702 where the brightness of the display is maintained at the current brightness. If the temperature data is below the threshold at block 700, the method passes to block 704 where the brightness of the display is increased. In one embodiment, the drive signals to the display (i.e., the stimulus received by the display) are adjusted to cause the brightness of the display to increase.

In contrast, the method shown in FIG. 8 compensates for warmer temperatures by decreasing the brightness of the display so the display maintains a relatively consistent brightness regardless of the temperature. After the receiver device receives temperature data at block 600, a determination can be made as to whether or not the temperature data is above a given threshold (block 800). As previously described, the threshold can be a single threshold or a set of multiple thresholds. If the temperature data is not above the threshold, the process continues at block 802 where the brightness of the display is maintained at the current brightness. If the temperature data is above the threshold, the method passes to block 804 where the brightness of the display is decreased. As one example, the drive signals to the display (i.e., the stimulus received by the display) are adjusted to cause the brightness of the display to increase.

Other embodiments can perform the methods shown in FIGS. 7 and 8 differently. Blocks can be added or omitted. As one example, block 702 or block 800 can be omitted in some embodiments. Instead, one or more operations of the electronic device can be monitored, and if needed, adjusted each time the temperature data is received at block 600. For example, an operation may be adjusted only if the temperature data has changed since the last time temperature data was received.

Referring now to FIG. 9, there is shown a flowchart of one example method of managing a haptic output in a receiver device based on temperature. Embodiments can use any suitable type of haptic device to provide haptic feedback to a user. In one non-limiting example, a linear actuator can be used to produce haptic feedback for a user.

In some situations, a user's ability to detect or perceive (either consciously or unconsciously) a haptic output can be affected by temperature. As one example, a user's sensitivity to a haptic output may decrease as the temperature becomes colder. As another example, a user's sensitivity to a haptic output may increase as the temperature warms. However, as the temperature continues to grow hotter, the user's sensitivity to the haptic output may decrease after a given high temperature. Embodiments can adjust the operation of the haptic mechanism to compensate for varying temperatures.

Initially, the receiver device receives temperature data at block 600. A determination may then be made as to whether or not the temperature data is below a given threshold (block 702). As described earlier, the threshold can be a single threshold or a set of multiple thresholds. If not, the process passes to block 900 where the haptic output is output at a non-adjusted or default level. If the temperature data is below the threshold, the method continues at block 902 where the haptic output provided to the user is increased. In one embodiment, the drive signal to the haptic mechanism (e.g., the stimulus received by the linear actuator) is adjusted to cause the haptic mechanism to increase the force of the haptic output.

In some embodiments, an electronic device, such as the receiver device 104 in FIG. 1, may be configured to provide an alert to a user based on an event or on detected user inactivity. Each alert can take the form of a stimulus that is delivered as a haptic alert, a visual alert, an audio alert, or various combinations of these alerts. As one example, an electronic device can produce a haptic alert when the user receives a text message or email. As another example, an electronic device can produce an audio alert to remind the user to an upcoming calendar entry.

An I/O device (e.g., 306 in FIG. 3) can include a haptic mechanism that produces haptic feedback in the electronic device (e.g., on a surface of the receiver device 104 such as the display or the enclosure). The haptic mechanism can be used to produce a haptic alert. As one non-limiting example, the haptic mechanism can be a linear electromagnetic actuator.

Additionally or alternatively, an I/O device may include a light source that is used to produce a visual alert. Any suitable type of light source may be used. As one example, the light source can be one or more light emitting diodes. A display (e.g., display 314) can be used to output a visual alert. As one example, the alert may be output by the display around only the periphery or edges of the display, or along a subset of the edges (e.g., one or two) of the display.

Additionally or alternatively, an I/O device can include an element that generates an audio output, and the element may be used to produce an audio alert. For example, a speaker can receive signals from a processing device and generate an audio output based on the received signals. Example audio outputs include, but are not limited to, a tone and a musical composition.

Additionally, in some embodiments an electronic device can output one or more priming cues to a user prior to outputting an alert on the electronic device. Each priming cue can take the form of a stimulus that is delivered as a haptic priming cue, a visual priming cue, an audio priming cue, or various combinations of these priming cues. The priming cue can be perceived by the user either consciously or subconsciously. A priming cue can prepare the user to perceive the stimulus of the alert, and in some situations, the priming cue may reduce a user's reaction time for perceiving the alert. In some embodiments, the priming cue may not be noticeable by the user, but instead causes the user to be in a state of heightened awareness that makes the user more likely to perceive an alert that exceeds a perceptual threshold (e.g., is sufficiently loud, bright, forceful, stifling, and so on).

In some situations, a user may be less likely to detect one type of alert or priming cue compared to another type of alert or priming cue due at least in part to the temperature or environmental conditions. For example, a user living in a location that experiences cold and snowy winters can be expected to wear a heavy coat, a scarf, and a hood or earmuffs during the winter. The heavy coat and/or the hood can make it difficult for a user to perceive or hear an audio alert or audio priming cue. Thus, a receiver device can select an alert or priming cue a user is more likely to perceive based on environmental data such as temperature.

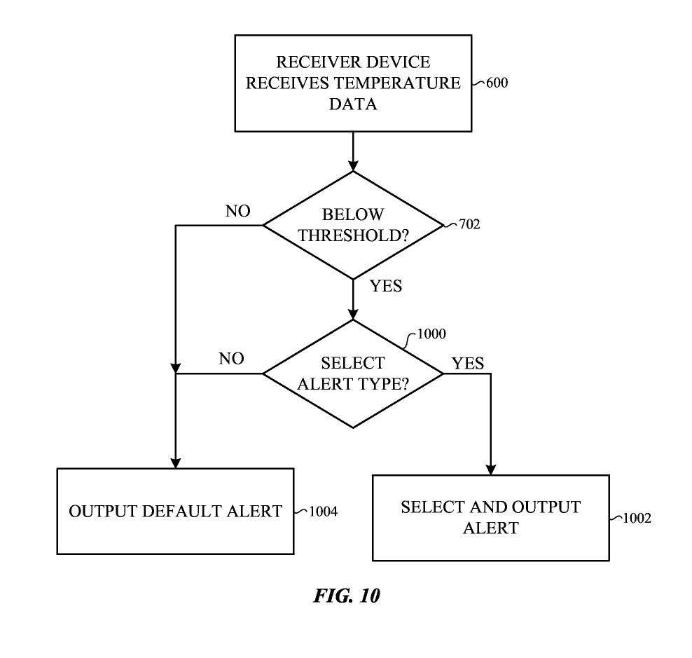

FIG. 10 is a flowchart of a method of selecting an alert type in a receiver device based on temperature. Initially, the receiver device receives temperature data at block 600. A determination may then be made as to whether or not the temperature data is below a given threshold (block 702). If the temperature is below the threshold, the process passes to block 1000 where a determination is made as to whether or not an alert type is to be selected based on the temperature. In one example embodiment, a user can enable alert type selection based on temperature through a user preference menu or a control panel. Alternatively, a processing device can be configured to select the alert type based on temperature.

If the temperature is not below the threshold at block 702, or if it is determined at block 1000 that the alert type will not be selected, the method continues at block 1002 where a predetermined or default alert is output. In an example embodiment, an application program or a user can select the type of alert that is the default alert.

If the alert type is to be selected based on temperature, the process passes to block 1004 where the alert is selected and output to the user. In an example embodiment, an application program or a processing device can select the type of alert to be output on the electronic device.

Additionally or alternatively, in some embodiments the alert type may be selected when the temperature data is above a threshold. Additionally or alternatively, the method of FIG. 10 can be used to select a priming cue based on environmental data such as temperature.

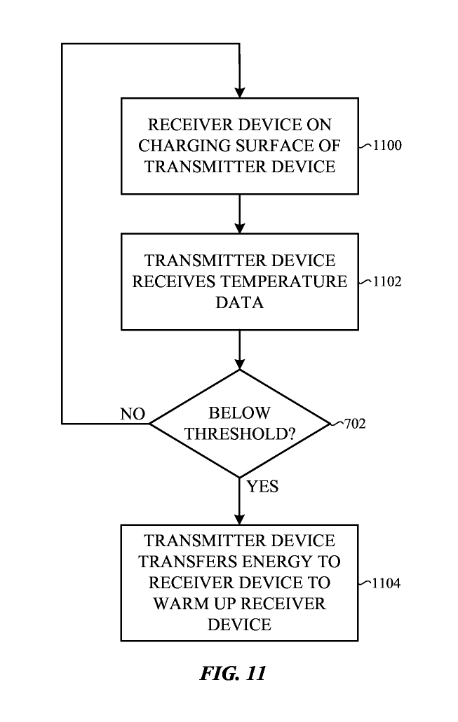

Referring now to FIG. 11, there is shown a flowchart of a method of operating the inductive energy transfer system shown in FIG. 1 based on temperature. Initially, the interface surface of the receiver device is mated with the interface surface of the transmitter device (block 1100). The transmitter device can then receive temperature data at block 1102. In other embodiments, the receiver device may receive the temperature data and transmit the temperature data to the transmitter device or the transmitter device can receive the temperature data from an external device.

A determination may then be made as to whether or not the temperature data is below a given threshold (block 702). The threshold can be a single threshold or a set of multiple thresholds. If the temperature data is below a threshold, the process continues at block 1104 where the transmitter device transfers energy to the receiver device to warm up (i.e., increase the temperature of) the receiver device. The operations of one or more devices in the receive device may operate more efficiently and/or more effectively when the receiver device is located in a cold temperature and the temperature of the receiver device is increased.

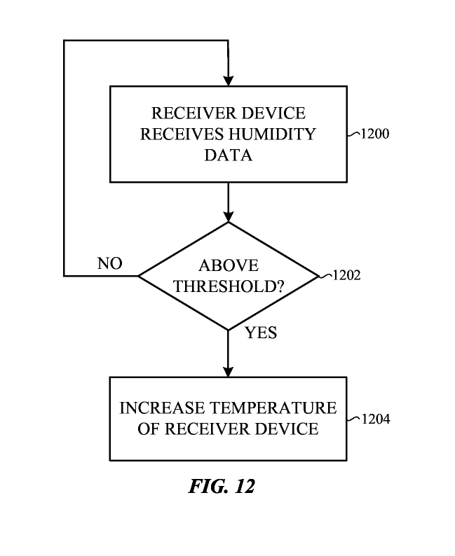

Environmental conditions in addition to, or other than temperature can be used to adjust the operation of one or more devices in an electronic device. As one example, humidity data can be used to modify the operation of a device. FIG. 12 is a flowchart of a method of operating the receiver device shown in FIG. 1 based on humidity. Initially, the receiver device receives humidity data at block 1200. The receiver device can receive the humidity data in any suitable manner. As one example, the humidity data may be obtained by a humidity sensor in the receiver device. As another example, the receiver device can receive humidity data from an external device using a network communication interface.

A determination may then be made as to whether or not the humidity data is above a given threshold (block 1202). As described earlier, the threshold can be a single threshold or a set of multiple thresholds. If the humidity data is above the threshold, the process continues at block 1204 where the temperature of the receiver device is increased. Increasing the temperature of the receiver device can reduce condensation between the exterior surface of the receiver device and the user's skin. As one example, the inductive energy system in the receiver device can operate to increase the temperature of the receiver device.

Other embodiments can adjust the operation of different devices or operations based on humidity. As one example, the operation of a biometric sensor can be adjusted based on humidity. As another example, a device or operation can be turned off temporarily or periodically to reduce the temperature of the receiver device.

Embodiments can adjust the operation of one or more devices in an electronic device based on one or more environmental conditions. The operations of the one or more devices can vary over time; the operations can be adjusted continuously, periodically or at select times. When the operations of two or more devices are modified, the operations can be adjusted simultaneously, consecutively, or with some overlap in time. As described previously, the operations of a device can be modified using a single threshold or multiple thresholds. The thresholds can be determined or selected based on one or more factors. Example factors include, but are not limited to, the environmental condition (e.g., temperature or humidity), the device operations to be adjusted, and/or the type of electronic device.

Additionally, the operations of devices other than the display and the haptic mechanism can be adjusted based on one or more environmental conditions. For example, the operations of a touch device, an audio device (e.g., speaker, microphone), and a force sensing device can be adjusted based on one or more environmental conditions.

Additionally, an external device can transmit signals to manage the operations of one or more devices in an electronic device. For example, the external device 318 shown in FIG. 3 can transmit signals to the electronic device 300 that cause the operations of a device (e.g., the display) to be modified based on one or more environmental conditions. Similarly, the electronic device 300 can transmit signals to the external device 318 to manage the operations of one or more devices in the external device 318. In some embodiments, the signals are transmitted between the network communication interface 312 in the electronic device and a network communication interface (not shown) in the external device 318. A processing device can be configured to determine if the operation of one or more devices is to be adjusted based on environmental data, such as temperature. Additionally or alternatively, the processing device can be configured to modify an operation based on environmental data (e.g., the processing device may modify a stimulus received by the device performing the operation).

Various embodiments have been described in detail with particular reference to certain features thereof, but it will be understood that variations and modifications can be effected within the spirit and scope of the disclosure. And even though specific embodiments have been described herein, it should be noted that the application is not limited to these embodiments. In particular, any features described with respect to one embodiment may also be used in other embodiments, where compatible Likewise, the features of the different embodiments may be exchanged, where compatible.

What is claimed is:

1. A method of managing an operation of a device in a receiver device that is configured to be included in an inductive energy transfer system, the method comprising:
receiving environmental data;
determining whether to adjust an operation of the device in the receiver device based on the environmental data; and
if the operation of the device in the receiver device is to be adjusted based on the environmental data, adjusting the operation of the device.

2. The method as in claim 1, wherein determining whether to adjust the operation of the device in the receiver device based on the environmental data comprises:
determining whether the environmental data is below a threshold value; and
if the environmental data is below the threshold value, adjusting the operation of the device.

3. The method as in claim 2, wherein the device in the receiver device comprises a display.

4. The method as in claim 3, wherein adjusting the operation of the display comprises increasing a brightness of the display based on the environmental data.

5. The method as in claim 3, wherein adjusting the operation of the display comprises decreasing a brightness of the display based on the environmental data.

6. The method as in claim 2, wherein the device in the receiver device comprises a haptic mechanism.

7. The method as in claim 6, wherein adjusting the operation of the haptic mechanism comprises increasing a haptic output of the haptic mechanism based on the environmental data.

8. A method of managing an operation of a device in an receiver device configured to be included in an inductive energy transfer system, the method comprising:
receiving temperature data;
determining whether to adjust an operation of the device in the receiver device based on the temperature data; and
if the operation of the device in the receiver device is to be adjusted based on the temperature data, adjusting the operation of the device.

9. The method as in claim 8, wherein determining whether to adjust the operation of the device in the receiver device based on the temperature data comprises:
determining whether the temperature data is equal to or less than a threshold value; and
if the temperature data is less than the threshold value, adjusting the operation of the device.

10. The method as in claim 9, wherein the device comprises a haptic mechanism and a haptic output of the haptic mechanism is increased based on the temperature data being less than the threshold value.

11. The method as in claim 9, wherein the device in the receiver device comprises a display and a brightness of the display is increased based on the temperature data being less than the threshold value.

12. The method as in claim 8, wherein determining whether to adjust the operation of the device in the receiver device based on the temperature data comprises:
determining whether the temperature data is equal to or greater than a threshold value; and
if the temperature data is equal to or greater than the threshold value, adjusting the operation of the device.

13. The method as in claim 12, wherein the device in the receiver device comprises a display and a brightness of the display is decreased based on the temperature data being equal to or greater than the threshold value.

14. A receiver device for an inductive energy transfer system, comprising:
an environmental sensor;
a network communication interface; and
a processing device configured to receive environmental data from at least one of the environmental sensor or the network communication interface and adjust an operation in the receiver device based on the environmental data.

15. The receiver device as in claim 14, wherein a brightness of a display is adjusted based on the received environmental data.

16. The receiver device as in claim 14, wherein a haptic output of a haptic mechanism is adjusted based on the environmental data.

17. A transmitter device for an inductive energy transfer system, comprising:
an environmental sensor;
a network communication interface; and
a processing device configured to receive environmental data from at least one of the environmental sensor or the network communication interface and adjust an operation in the transmitter device based on the environmental data.

18. The transmitter device as in claim 17, wherein a brightness of a display is adjusted based on the received environmental data.

19. The transmitter device as in claim 17, wherein a haptic output of a haptic mechanism is adjusted based on the environmental data.

20. An inductive energy transfer system, comprising:
a transmitter device, comprising:
first communication circuitry; and
a receiver device, comprising:
an environmental sensor;
a network communication interface;
second communication circuitry; and
a processing device operably connected to the environmental sensor, the network communication interface, and the second communication circuitry;
wherein the processing device is configured to receive environmental data from at least one of the environmental sensor, the network communication interface, or a communication channel established between the first and second communication circuitry and adjust an operation in the receiver device based on the environmental data.

21. The inductive energy transfer system as in claim 20, wherein the environmental sensor comprises a temperature sensor.

22. The inductive energy transfer system as in claim 20, wherein a brightness of a display is adjusted based on the received environmental data.

23. The inductive energy transfer system as in claim 20, wherein a haptic output of a haptic mechanism is adjusted based on the environmental data.

24. An inductive energy transfer system, comprising:
a transmitter device, comprising:
an environmental sensor;
a network communication interface;
first communication circuitry; and
a processing device operably connected to the environmental sensor, the network communication interface, and the first communication circuitry; and
a receiver device, comprising:
second communication circuitry;
wherein the first processing device is configured to receive environmental data from at least one of the environmental sensor, the network communication interface, or a communication channel established between the first and second communication circuitry and adjust an operation in the transmitter device based on the environmental data.

25. The inductive energy transfer system as in claim 24, wherein the environmental sensor comprises a temperature sensor.

26. The inductive energy transfer system as in claim 24, wherein a brightness of a display is adjusted based on the received environmental data.

27. The inductive energy transfer system as in claim 24, wherein a haptic output of a haptic mechanism is adjusted based on the environmental data.
